(19) United States
(12) Patent Application Publication
(10) Pub. No.: US 2006/0063524 A1
(43) Pub. Date: Mar. 23, 2006

(54) Apparatus and method for receiving digital multimedia broadcasting services in wireless communication system

(75) Inventor: Seok-Min Hwang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/232,274

(22) Filed: Sep. 21, 2005

(30) Foreign Application Priority Data
Sep. 21, 2004 (KR) 2004-75692

(51) Int. Cl. H04Q 7/20

(52) U.S. Cl. 455/423; 455/67.11; 455/452.2

(57) ABSTRACT

An apparatus and a method for receiving broadcasting services in a Digital Multimedia Broadcasting (DMB) system, which provide convenience to users. Such a DMB receiving apparatus includes an Radio Frequency (RF) receiver unit for receiving RF signals, a modem receiver for measuring energy values of the pilot signal to perform initial synchronization, a controller unit for comparing the energy values with a predetermined threshold value to derive a broadcasting channel situation, and a display unit for indicating the broadcasting channel status derived from the controller unit. The receiving apparatus and method enables a terminal of the DMB system to minimize power consumption by checking the current electric field situation to stop unnecessary operations. Also, the user is informed of the current electric field status by using only simple initial synchronization, thereby minimizing an inconvenience in which the user watches indistinct broadcasting in an unfavorable channel environment.

### PRIORITY

This application claims priority to an application entitled “Apparatus and Method for Receiving Digital Multimedia Broadcasting Services in Wireless Communication System” filed in the Korean Industrial Property Office on Sep. 21, 2004 and assigned Serial No. 2004-75692, the contents of which are incorporated herein by reference.

### BACKGROUND OF THE INVENTION

1. Field of the Invention

The present invention relates to a receiving apparatus and a receiving method for a wireless communication system, and more particularly to an apparatus and a method for receiving digital multimedia broadcasting services in a wireless communication system.

2. Description of the Related Art

In general, digital broadcasting refers to a system for providing high picture quality, Compact Disc (CD)-level sound quality and high-level services to users in place of conventional analog broadcasting. Such digital broadcasting has evolved into two types, terrestrial-wave broadcasting and satellite broadcasting. Here, the terrestrial-wave broadcasting refers to a digital broadcasting scheme enabling users to receive broadcasting services through a terrestrial repeater. In contrast with this, the satellite broadcasting refers to a digital broadcasting scheme in which digital broadcasting is received using a satellite as a repeater. A representative of the digital broadcasting is a digital multimedia broadcasting (DMB) service. The DMB service is also classified into two schemes, terrestrial-wave DMB and satellite DMB. The terrestrial-wave DMB refers to a DMB scheme providing broadcasting services to users through a terrestrial repeater as stated above.

The satellite DMB does not use the terrestrial repeater, but a satellite for providing broadcasting services. Hereinafter, the satellite DMB will be described in detail with reference to FIG. 1. Referring to FIG. 1, a satellite DMB broadcasting center 100 transmits broadcasting signals to a DMB satellite 106 through a Ku-band (12 to 13 GHz) in a time division multiplex (TDM) scheme (reference numeral 102) and a code division multiplex (CDM) scheme (reference numeral 104). Then, the DMB satellite 106 receives the broadcasting signals and transmits the received signals 102, 104 again to ground receiver terminals 116 or a gap filler repeater 108 corresponding to the terrestrial repeater.

The DMB satellite 106 converts the received broadcasting signals into TDM signals 110 of the Ku-band and CDM signals 112 of an S-band (2 to 3 GHz) and then transmits them to the ground. The DMB satellite 106 transmits the broadcasting signals to the gap filler repeater 108 so that the broadcasting signals transmitted by the DMB satellite 106 can be received even in shadow areas such as an underground area. The gap filler repeater 108 receives the broadcasting signals and converts them into S-band signals to provide the broadcasting services to DMB terminals located in the shadow areas.

There are many kinds of DMB terminals including fixed dedicated terminals, such as HiFi-type terminals which are mostly available at home, mobile dedicated terminals used for vehicles, and portable terminals such as a Personal Digital Assistant (PDA), a notebook, a cellular phone and so forth.

Such DMB terminals are inconvenient in that users wait for a long time when they select their own desired channels because they don't know whether or not it is possible to receive the DMB broadcasting. Also, when the DMB terminals are located in shadow areas, channel conditions are not good and thus the DMB terminals continue to perform operations for receiving the DMB broadcasting when DMB service is unavailable, thereby causing unnecessary power consumption.

### SUMMARY OF THE INVENTION

Accordingly, the present invention has been made to solve at least the above-mentioned problems occurring in the prior art, and an object of the present invention is to provide an apparatus and a method for receiving broadcasting services in a DMB system, which can indicates a reception electric field status to a user.

A further object of the present invention is to provide an apparatus and a method for receiving broadcasting services in a DMB system, which can minimize power consumption when broadcasting services are received.

In order to accomplish these objects, in accordance with one aspect of the present invention, there is provided a method for receiving broadcasting services to a mobile terminal in a DMB system which transmits frames through a pilot signal, the frames being constructed such that a superframe consists of at least two frames, one frame consists of a plurality of subframes, and one subframe has a pilot symbol period and a pilot data period. The method including a first step of receiving the pilot signal; a second step of comparing an energy value of the pilot signal, which is measured in an initial synchronization operation, with a predetermined threshold value to derive an electric field status (a measure of the quality of reception) of a broadcasting service channel; and a third step of indicating the electric field status on a display unit of the mobile terminal.

The initial synchronization operation includes the processes of synchronizing pilot symbols and pilot data from the received pilot signal, synchronizing the subframes from the received pilot signal, and synchronizing the superframe from the received pilot signal.

The second step includes the processes of comparing an energy value Ep measured in the pilot symbol period with the predetermined threshold value, comparing a difference value between a maximum energy value Emax and a secondary large energy value Esec from among a plurality of energy values measured during the synchronization of the subframes with the predetermined threshold value, and deriving the electric field status of the broadcasting service channel based on the compared values.

The electric field status is represented as a service unavailable state or a predetermined stepwise status.

In order to accomplish the above-mentioned objects, in accordance with another aspect of the present invention, there is provided a terminal for a DMB system in which a base station transmits frames through a pilot signal, the frames being constructed such that a superframe consists of at least two frames, one frame consists of a plurality of subframes, and one subframe has a pilot symbol period and a pilot data period. The terminal includes a Radio Frequency (RF) receiver unit for receiving RF signals transmitted from the base station; a modem receiver for measuring energy values of the pilot signal to perform initial synchronization; a controller unit for comparing the energy values with a predetermined threshold value to derive a broadcasting service channel status; and a display unit for indicating the broadcasting service channel situation derived from the controller unit.

The modem receiver includes a searcher for searching the pilot symbol periods and the pilot data periods of the pilot signal and a signal rake receiver for measuring the energy values of the pilot signal.

The initial synchronization comprises synchronization of pilot symbols and pilot data from the received pilot signal, synchronization of the subframes from the received pilot signal, and synchronization of the superframe from the received pilot signal.

The controller unit compares an energy value Ep measured in the pilot symbol period with the predetermined threshold value, compares a difference value between a maximum energy value Emax and a secondary large energy value Esec from among a plurality of energy values measured during the synchronization of the subframes with the predetermined threshold value, and derives the electric field status of the broadcasting service channel based on the compared values.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing a network structure of a DMB system;

FIG. 2 is a block diagram of a DMB terminal in accordance with a preferred embodiment of the present invention;

FIG. 3 is a schematic view showing a pilot channel structure of the DMB system;

FIG. 4 is a block diagram showing an internal structure of a modem receiver in accordance with a preferred embodiment of the present invention; and

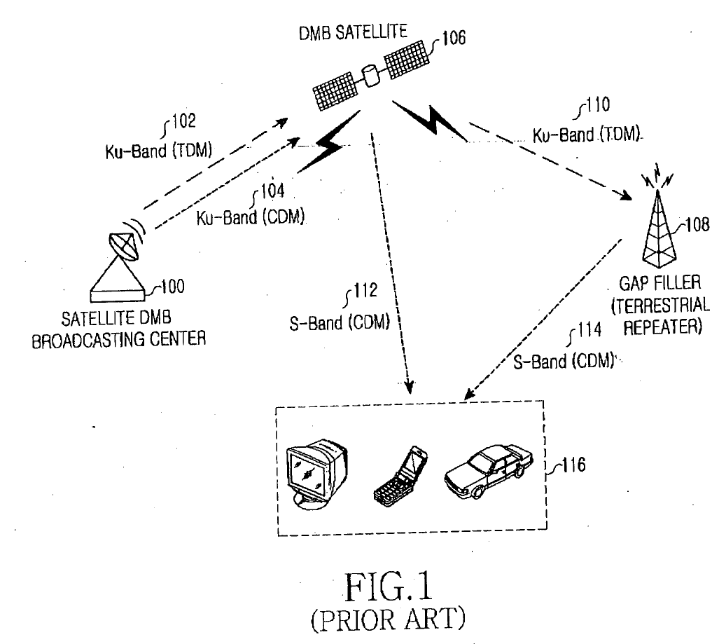

FIG.. 5 is a flowchart for a method for receiving DMB services in accordance with a preferred embodiment of the present invention.

### DETAILED DESCRIPTION OF THE PREFERRED EMBODIMENT

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

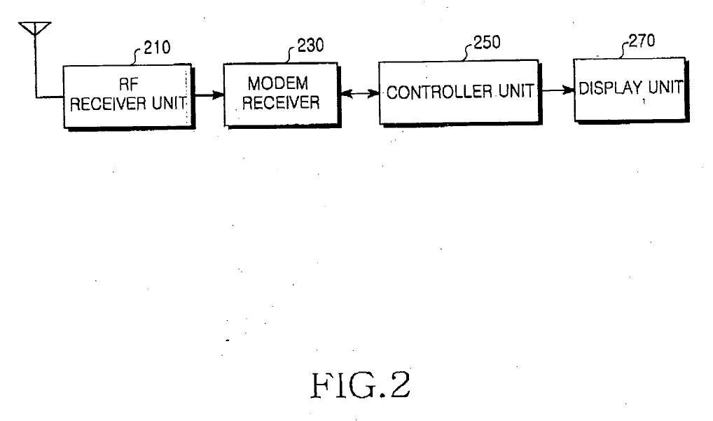

FIG. 2 illustrates a DMB terminal in accordance with a preferred embodiment of the present invention in a block diagram. Referring to FIG. 2, the DMB terminal includes an RF receiver unit 210 for receiving signals transmitted through a DMB satellite or a gap filler as a terrestrial repeater, a modem receiver 230 for measuring an energy value of each frame from the signal received to the RF receiver 210, a controller unit 250 for checking the measured energy value to control an initial synchronization process of the terminal, and a display unit 270 for visually indicating guide information which represents whether or not it is possible to receive a service channel output from the controller unit 250. The guide information represents a service unavailable state or a predetermined stepwise status in comparison with a predetermined threshold value.

Hereinafter, a pilot channel structure in the DMB service will be described first and then a structure of the DMB terminal in accordance with the present invention will be described in more detail for the sake of promoting understanding about the present invention.

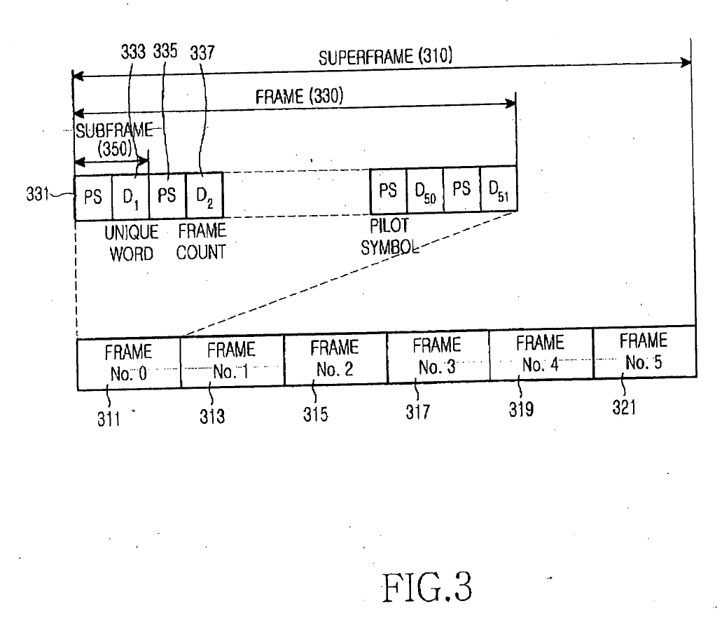

FIG. 3 illustrates a structure of a superframe which is transmitted over a pilot channel in a common DMB service. Referring to FIG. 3, the superframe 310 consists of 6 frames 311 to 321, each of the frames 311 to 321 consists of 51 subframes 350, and each of the subframes 350 consists of a pilot symbol (PS) period and a pilot data (D) period. Thus, a pilot signal includes pilot symbols and pilot data.

The subframe has a frame cycle of 250 μs. Since one frame 330 consists of 51 subframes, it has a frame cycle of 12.750 ms. Consequently, the superframe 310 consisting of 6 frames 311 to 321 has a frame cycle of 76.5 ms.

Of the pilot signal, the pilot symbol includes synchronization information for the subframe, and the pilot data includes not only synchronization information for each frame 330 and the superframe 310, but also an error correction code and broadcasting information for decoding the broadcasting channel.

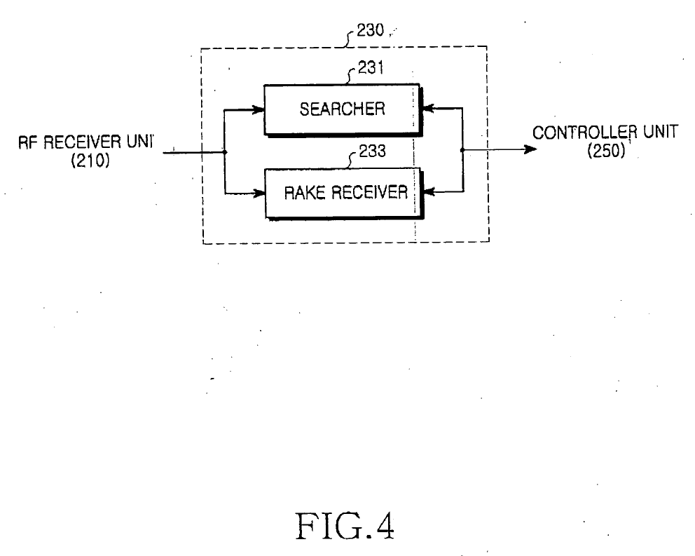

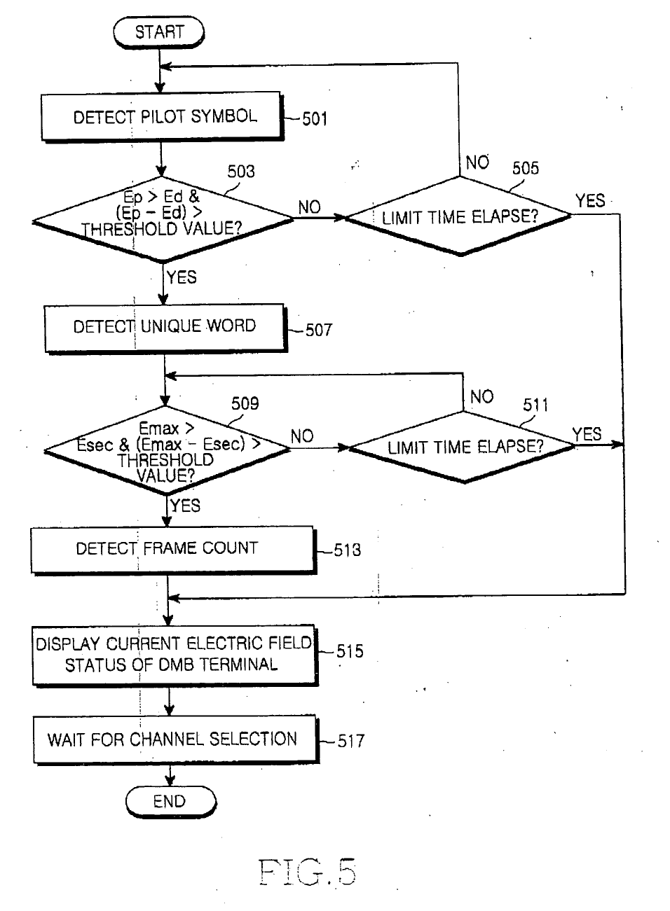

The controller unit 250 in FIG. 2 performs initial synchronization of the system by using energy values measured in the modem receiver 230. The initial synchronization includes a pilot symbol detection process, a unique word detection process and a frame count detection process. The pilot symbol detection process for synchronizing the subframe 350 is implemented by measuring energy values of each of the pilot symbol periods 331, 335, . . . and each of the pilot data periods 333, 337, . . . . The unique word detection process for synchronizing the respective frames 330 is implemented by detecting the first pilot data period (D1) 333 of the pilot signal. In the frame count detection process, synchronization of the superframe 310 is performed by detecting the second pilot data period (D2) 337 of the pilot signal. Hereinafter, a more detailed description will be given for such an initial synchronization detection process and a method for indicating an electric field status of the terminal with reference to FIG. 4.

FIG. 4 is a block diagram illustrating an internal structure of the modem receiver 230 shown in FIG. 2. In the following description, the initial synchronization detection process using the received pilot signal will be described with reference to FIGS. 3 and 4.

Referring to FIG. 3, the modem receiver 230 internally includes a searcher 231 for performing detection operations for the pilot symbol periods and the pilot data periods of the pilot signal and a rake receiver 233 for measuring and cumulating energy values necessary for the respective frames of the pilot signal.

First, the rake receiver 233, having received the pilot signal, checks the pilot symbol period and the pilot data period subframe by subframe 350, 351, . . . , The pilot symbol period 331, 335, . . . and the pilot data period 333, 337, . . . are so configured as to have the same length as each other. The pilot symbol period is coded with one numeral, and the pilot data period is coded with a mixture of numerals ‘0’ and ‘1’. Thus, the rake receiver 233 cumulates energy values period by period to transfer the energy values to the controller unit 250. Thereupon, the controller unit 250 recognizes a larger value of the two cumulative energy values as a pilot symbol energy value Ep and recognizes a smaller value as a pilot data energy value Ed. In order to confirm that the synchronization of the subframe 350 is correct, the controller unit 250 also checks whether the value Ep is larger than the value Ed and a difference value between the values Ep and Ed is larger than a predetermined threshold value. If such conditions are satisfied, the controller unit 250 concludes that the pilot symbol detection operation is completed and proceeds to a next step, the unique word detection process. However, if the conditions are not satisfied, the controller unit 250 repeats the above-described process for a predetermined limit time. If the conditions are not satisfied even after the repetition, the controller unit 250 indicates a message representing ‘Service Unavailable’ on the display unit 270.

In the unique word detection process, energy values corresponding to correlation degrees between the pilot data and a unique word pattern value, which is already known to the rake receiver 233, are measured in at least one frame period. The rake receiver 233 detects and selects the four largest values from among the measured correlation degrees of the respective pilot data to transfer them to the controller unit 250. The controller unit 250 then checks if the largest energy value Emax of the correlation degrees transferred from the rake receiver 233 is larger than a predetermined threshold value, and a difference value between the largest energy value Emax and a secondary large energy value Esec is larger than a predetermined threshold value. If such conditions are satisfied, the controller unit 250 determines that the unique word has been detected and synchronization between the frames is correct. However, if the conditions are not satisfied, the controller repeats the same process for a predetermined limit time as in the pilot symbol detection process. If the conditions are not satisfied even after the repetition, the controller unit 250 indicates a message representing ‘Service Unavailable’ on the display unit 270.

In the frame count process, a frame count value is transmitted and input to the D2 337, a part of the pilot data, and the transmitted frame count value is read to be informed to the controller unit 250.

In reading the frame count value, the D2 337 consists of total 32 bits, and the frame count value of 4 bits, which is coded with ‘−1’ or ‘1’, is repeatedly input eight times. A frame count detector cumulates energy values of the respective bits of the 4 bits, and regards the largest value of the respective bits as ‘1’ to detect the frame count value. For example, if the frame count value is ‘2’, the value of the D2 337 as ‘−1 −1 1 −1’ is repeated eight times. Thus, the frame count detector can detect ‘2’ by cumulating the energy values in the frame count process, and the so-detected frame count value is provided to the controller unit 250.

When all the initial synchronization processes are completed, the controller unit 250 compares the measured energy values according to the respective initial synchronization processes with the threshold value for the current channel status to indicate the current channel electric field status on the display unit 270 so that a user can be aware of the current electric field status. The current electric field status may be represented as ‘Broadcasting Reception Available or Unavailable’ or as a predetermined stepwise status in comparison with the threshold value.

A method for receiving DMB services in accordance with a preferred embodiment of the present invention will be described with reference to FIGS. 4 and 5.

FIG. 5 illustrates a flowchart for the method for receiving DMB services in accordance with a preferred embodiment of the present invention.

Referring to FIG. 5, if a pilot signal received to the RF receiver unit 210 is input to the modem receiver 230, the pilot symbol detection process begins in step 501. First, the searcher 231 of the modem receiver 230 measures and cumulates energy values Ep and Ed of the respective pilot symbol periods and the pilot data periods. In step 503, the controller unit 250 having received the energy values checks if the value Ep is larger than the value Ed and a difference value between the values Ep and Ed is larger than a predetermined threshold value. If these conditions are satisfied, the controller unit 250 synchronizes the subframe and proceeds to step 507. However, if the conditions are not satisfied, the controller unit 250 checks in step 505 whether a predetermined limit time elapses. If the limit time is not yet reached, the pilot symbol detection process is repeatedly performed. If the limit time is exceeded, the controller unit 250 proceeds to step 515 to indicate a message representing ‘Service Unavailable’ on the display unit of the DMB terminal.

In the pilot symbol detection process, the current electric field status can be confirmed by means of the cumulative energy value in the pilot symbol periods. That is, as stated above, the energy of the current received pilot symbol periods is measured as cumulative energy of the pilot symbols. Such a measured cumulative energy value varies with the electric field status. That is, if the electric field status is favorable, a large energy value is derived, and if the electric field status is unfavorable, a small energy value is derived. Therefore, the current electric field status can be confirmed using the energy value. The energy values are stored in a table format in the controller unit 250, and are displayed as a message or guide information corresponding to the current electric field status on the display unit of the DMB terminal.

If the pilot symbol detection process is completed, the unique word detection process is executed in step 507. The rake receiver 233 measures energy values corresponding to correlation degrees between the pilot data and a unique word pattern value, which is already known to the rake receiver 233, in at least one frame period 330. Thereafter, in step 509, the controller unit 250 finds out the largest energy value Emax and a secondary large energy value from among the energy values and compares a difference value between the values Emax and Esec with a predetermined threshold value.

If the difference value exceeds the threshold value, the controller unit 250 synchronizes the frame 330 from the value Emax and proceeds to step 513. However, if the difference value does not exceed with the threshold value, the controller unit 250 checks in step 511 whether or not a predetermined limit time elapses. If the limit time is not yet reached, the unique word detection process is repeatedly performed. In contrast with this, if the limit time is exceeded, the controller unit 250 proceeds to step 515 to indicate a message representing ‘Service Unavailable’ on the display unit of the DMB terminal.

In the unique word detection process, since the value Emax is measured using a certain pattern known by the receiver and a correlation relation with the D1 336, the value Emax can represent the current electric field status. If the value Emax passes the threshold value, whether or not the value Esec also passes the threshold value may be checked. If the value Esec also passes the threshold value, this means that the unique word detection process is not properly executed, which shows that the electric field status is not good. However, if the value Esec does not pass the threshold value, the current electric field situation can be confirmed using the difference between the values Emax and Esec. That is, if the value Emax is extraordinarily larger than the value Esec, this means that the current electric field status is favorable. The controller unit 250 has the difference value between the values Emax and Esec in a table format, and compares the values Emax and Esec detected in the unique word detection process with the table to indicate the current electric field status on the display unit of the DMB terminal.

Once the synchronization of the frame 330 is completed in the unique word detection process, in step 509, the controller unit 250 synchronizes the superframe 310 by reading data value of the second pilot data (D2).

Using the above-mentioned processes, the energy values measured in the initial synchronization operations are compared with predetermined stepwise threshold values, and the current electric status is indicated on the display unit of the DMB terminal based on the comparison so that a user can the current electric filed status. Following this, in step 517, the DMB terminal stops all operations and waits for the user to determine any selection.

Here, a method for indicating the current electric field status may be performed in various ways. The electric filed status may be indicated by the energy values measured in the pilot symbol detection process or may be indicated by synthetically considering the energy values measured in each of the pilot symbol detection process and the unique word detection process.

In the present invention, not only a user can be aware of a broadcasting reception status of a DMB terminal, but also power consumption of the DMB terminal can be minimized because the DMB terminal does not automatically move forward to a next process when an initial electric field status is not favorable until the user issues a command.

As described above, the present invention enables a terminal of a DMB system to minimize power consumption by checking the current electric field status to stop unnecessary operations. Also, the present invention informs a user of the current electric field status by using only simple initial synchronization, thereby minimizing annoyance and inconvenience in which the user watches indistinct broadcasting in an unfavorable channel environment.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for receiving broadcasting services to a mobile terminal in a Digital Multimedia Broadcasting (DMB) system which transmits frames through a pilot signal, the frames being constructed such that a superframe consists of at least two frames, one frame consists of a plurality of subframes, and one subframe has a pilot symbol period and a pilot data period, the method comprising:
receiving the pilot signal;
comparing an energy value of the pilot signal, which is measured in an initial synchronization operation, with a predetermined threshold value to derive an electric field status of a broadcasting service channel; and
indicating the electric field status on a display unit of the mobile terminal.

2. The method as claimed in claim 1, wherein the initial synchronization operation comprises:
synchronizing pilot symbols and pilot data from the received pilot signal;
synchronizing the subframes from the received pilot signal; and
synchronizing the superframe from the received pilot signal.

3. The method as claimed in claim 2, wherein the step of comparing an energy value of the pilot signal comprises:
comparing an energy value Ep measured in the pilot symbol period with the predetermined threshold value; and
deriving the electric field status of the broadcasting service channel based on the compared values.

4. The method as claimed in claim 2, wherein the step of comparing an energy value of the pilot signal comprises:
comparing an energy value Ep measured in the pilot symbol period with the predetermined threshold value;
comparing a difference value between a maximum energy value Emax and a secondary large energy value Esec from among a plurality of energy values measured during the synchronization of the subframes with the predetermined threshold value; and
deriving the electric field status of the broadcasting service channel based on the compared values.

5. The method as claimed in claim 1, wherein the electric field status is represented as a service unavailable state or a predetermined stepwise status.

6. The method as claimed in claim 1, wherein the predetermined threshold value is stored in a controller unit of the terminal.

7. A terminal for a Digital Multimedia Broadcasting (DMB) system in which a base station transmits frames through a pilot signal, the frames being constructed such that a superframe consists of at least two frames, one frame consists of a plurality of subframes, and one subframe has a pilot symbol period and a pilot data period, the terminal comprising:
a Radio Frequency (RF) receiver unit for receiving RF signals transmitted from the base station; a modem receiver for measuring energy values of the pilot signal to perform initial synchronization;
a controller unit for comparing the energy values with a predetermined threshold value to derive a broadcasting service channel status; and
a display unit for indicating the broadcasting service channel status derived from the controller unit.

8. The terminal as claimed in claim 7, wherein the modem receiver comprises a searcher for searching the pilot symbol periods and the pilot data periods of the pilot signal and a signal rake receiver for measuring the energy values of the pilot signal.

9. The terminal as claimed in claim 7, wherein the initial synchronization comprises synchronization of pilot symbols and pilot data from the received pilot signal, synchronization of the subframes from the received pilot signal, and synchronization of the superframe from the received pilot signal.

10. The terminal as claimed in claim 9, wherein the controller unit compares an energy value Ep measured in the pilot symbol period with the predetermined threshold value, and derives the electric field status of the broadcasting service channel based on the compared values.

11. The terminal as claimed in claim 9, wherein the controller unit compares an energy value Ep measured in the pilot symbol period with the predetermined threshold value, compares a difference value between a maximum energy value Emax and a secondary large energy value Esec from among a plurality of energy values measured during the synchronization of the subframes with the predetermined threshold value, and derives the electric field status of the broadcasting service channel based on the compared values.

12. The terminal as claimed in claim 7, wherein the threshold value is previously stored in a memory of the controller unit.

13. The terminal as claimed in claim 7, wherein the electric field status is represented as a service unavailable state or a predetermined stepwise status.
